(19) United States
(12) Patent Application Publication
(10) Pub. No.: US 2025/0174156 A1
(43) Pub. Date: May 29, 2025

(54) ABDOMINAL SURGICAL SIMULATION MODEL HAVING INSUFFLATION CAPABILITY AND ASSOCIATED METHODS

(71) Applicant: INTUITIVE SURGICAL OPERATIONS, INC., Sunnyvale, CA (US)

(72) Inventor: Darius Eghbal, Sonoma, CA (US)

(73) Assignee: INTUITIVE SURGICAL OPERATIONS, INC., Sunnyvale, CA (US)

(21) Appl. No.: 18/956,083

(22) Filed: Nov. 22, 2024

Related U.S. Application Data
(60) Provisional application No. 63/603,669, filed on Nov. 29, 2023.

(51) Int. Cl. G09B 23/30; G09B 23/28

(52) U.S. Cl. CPC G09B 23/306; G09B 23/285

(57) ABSTRACT

An abdominal surgical simulation model includes a bottom tray and an animal tissue carried within the bottom tray. A convex support layer covers the bottom tray. A compliant layer is carried by the convex support layer to simulate abdominal skin in an insufflated state.

### PRIORITY APPLICATION(S)

This application is based upon U.S. provisional patent Application No. 63/603,669, filed Nov. 29, 2023, the disclosure which is hereby incorporated by reference in its entirety.

### FIELD OF THE INVENTION

The present invention is directed to surgical training, and more particularly, to an abdominal surgical simulation model that sustains insufflation and related methods.

### BACKGROUND OF THE INVENTION

Surgical procedures may be performed using open or general surgery, laparoscopic surgery, and/or robotically assisted surgery. To become qualified to perform surgical procedures, surgeons participate in comprehensive training to become proficient in the variety of tasks required to perform the procedures. Such tasks include inserting and directing surgical tools to anatomical features of interest such as tissue or organs, manipulating tissue, grasping, clamping, cutting, sealing, suturing, and stapling tissue, as well as other tasks. To gain proficiency, it is beneficial to allow surgeons to repeatedly practice these tasks for multiple different procedures. In addition, it can be beneficial to quantify training and performance of such tasks by surgeons, thereby enabling them to track progress and improve performance.

Various surgical training systems have been developed to provide surgical training. For example, training may be conducted on human cadavers. However, cadavers may be expensive and provide limited opportunities to train. In addition, a single cadaver may not allow the surgeon to repeatedly practice the same procedure. Surgical tissue models have also been utilized for surgical training. However, these tissue models may not be suitable for training minimally invasive procedures using laparoscopic or robotically assisted tools. In minimally invasive procedures, the surgical tools must be inserted into the body via natural orifices or small surgical incisions and then positioned near the anatomical features of interest.

Harvested porcine tissue has been used to develop surgical training models for use in thoracic and cardiac surgery because the anatomy of the porcine organs, such as the heart and lungs, are similar in anatomy to human organs. Use of harvested porcine tissue or other harvested animal tissue, however, is challenging when used with an abdominal simulation model that requires insufflation for robotic usability testing or in clinical training labs. Most abdominal simulation models used for insufflation do not have the ability to conform to an access port or hold insufflation pressure correctly to portray the behavior of an access port when used with surgical instruments. They typically are not designed to train in electrocautery. Many commercially available insufflation models are also not adaptable for use with harvested animal tissue or replaceable tissue plates, such as tissue cassettes that hold the harvested animal tissue.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

An abdominal surgical simulation model may comprise a bottom tray and animal tissue carried within the bottom tray. A convex support layer may cover the bottom tray. A compliant layer may be carried by the convex support layer to simulate abdominal skin in an insufflated state.

The convex support layer may have at least one opening therein to define an access port. Indicia may be on an outer surface of the compliant layer aligned with the at least one opening. The coupling arrangement may removably secure the compliant layer to the bottom tray. The coupling arrangement may define a gas tight seal for insufflation.

The bottom tray may have at least one opening therethrough and may comprise at least one of a fluid line and electrical line extending therethrough. The animal tissue may comprise harvested animal tissue. The harvested animal tissue may comprise harvested porcine tissue. The animal tissue may also comprise synthetic tissue. A base may be coupled to the animal tissue defining a tissue cassette, and wherein the tissue cassette is removably positioned within the bottom tray. An inner layer may be carried within the convex support layer.

Another aspect is directed to a method for making an abdominal surgical simulation model that may comprise mounting animal tissue, such as harvested animal tissue or synthetic tissue, within a bottom tray, mounting a convex support layer to cover the bottom tray, and mounting a compliant layer over the convex support layer to simulate abdominal skin in an insufflated state.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is an isometric view of the abdominal surgical simulation model having insufflation capability according to an example embodiment of the disclosure.

FIG. 2 is an end view of the abdominal surgical simulation model shown in FIG. 1.

FIG. 3 is a side elevation view of the abdominal surgical simulation model of FIG. 1.

FIG. 4 is another isometric view of the abdominal surgical simulation model with the convex support layer and compliant layer in outline to show the tissue cassette removably positioned within the bottom tray and carrying animal tissue, such as harvested animal tissue or synthetic tissue.

FIG. 5 is an end view of the abdominal surgical simulation model of FIG. 4.

FIG. 6 is a side elevation view of the abdominal surgical simulation model of FIG. 4.

FIG. 7 is an enlarged sectional view of the convex support layer and compliant layer forming the simulated abdominal skin.

FIG. 8 is an enlarged schematic view of the convex support layer showing openings to define an access port and a portion of the compliant layer broken away.

FIG. 9 is an exploded isometric view of another example of the convex support layer and compliant layer, and an inner layer carried within the convex support layer.

FIG. 10 is an environmental view of the abdominal surgical simulation model used in robotic surgery.

FIG. 11 is a flowchart showing a method for making the abdominal surgical simulation model.

FIG. 12 is a perspective view of a manipulator system according to an example embodiment of the disclosure.

FIG. 13 is a partial schematic view of an embodiment of a manipulator system having a manipulator arm with two instruments in an installed position according to the present disclosure.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

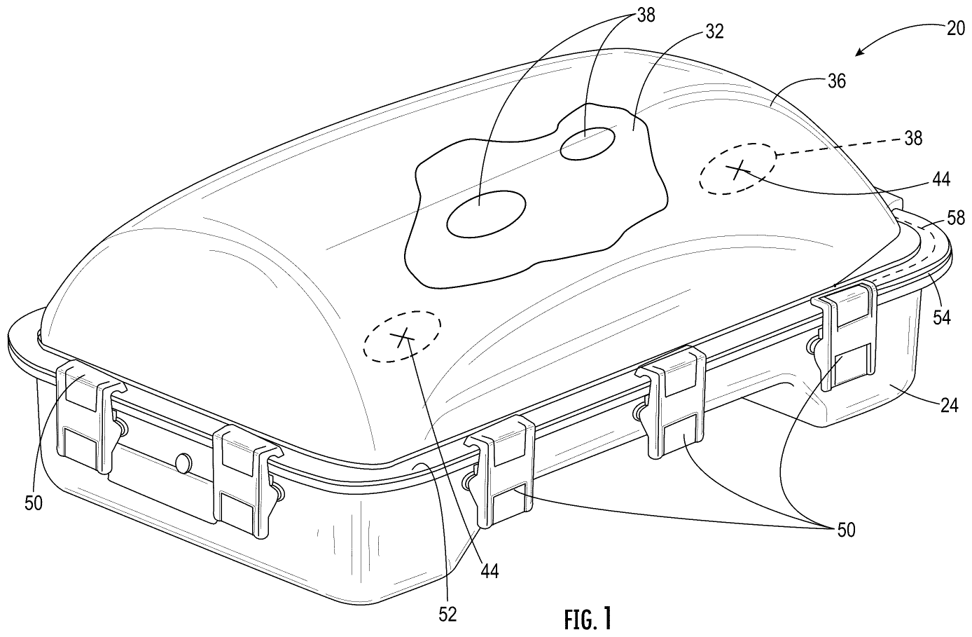

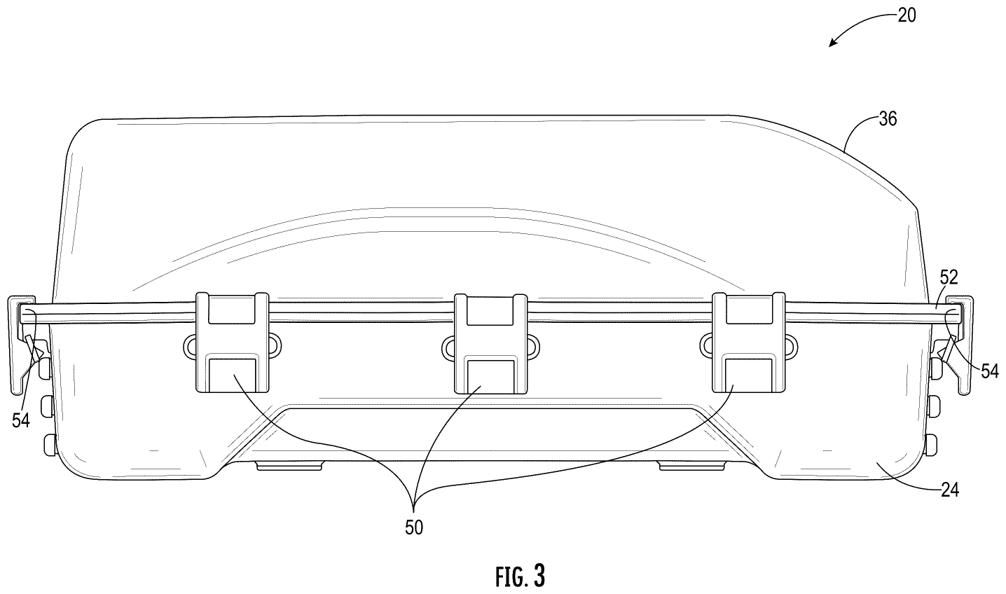

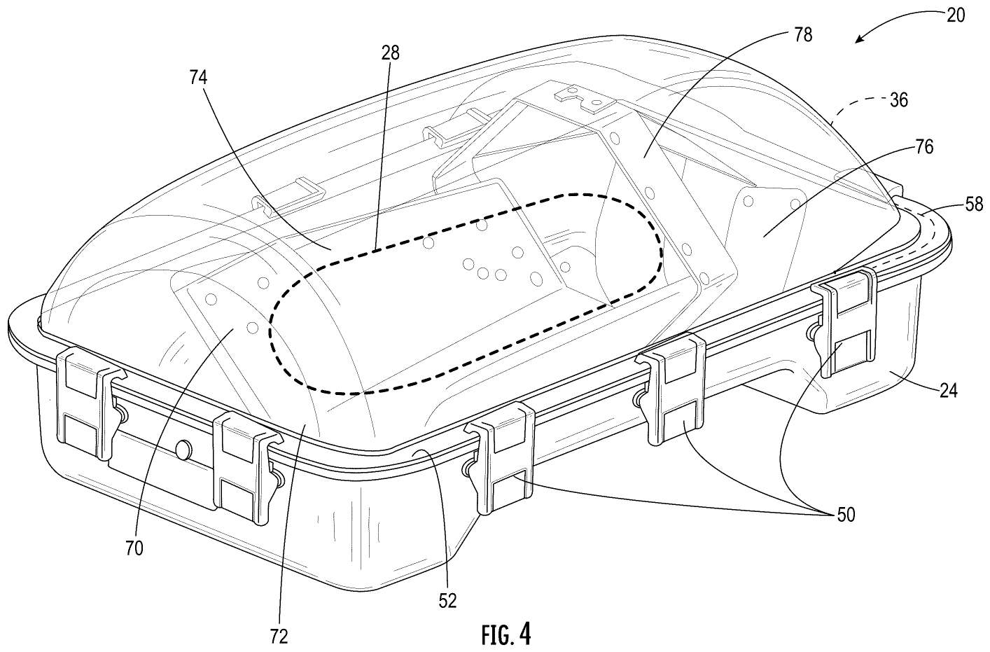

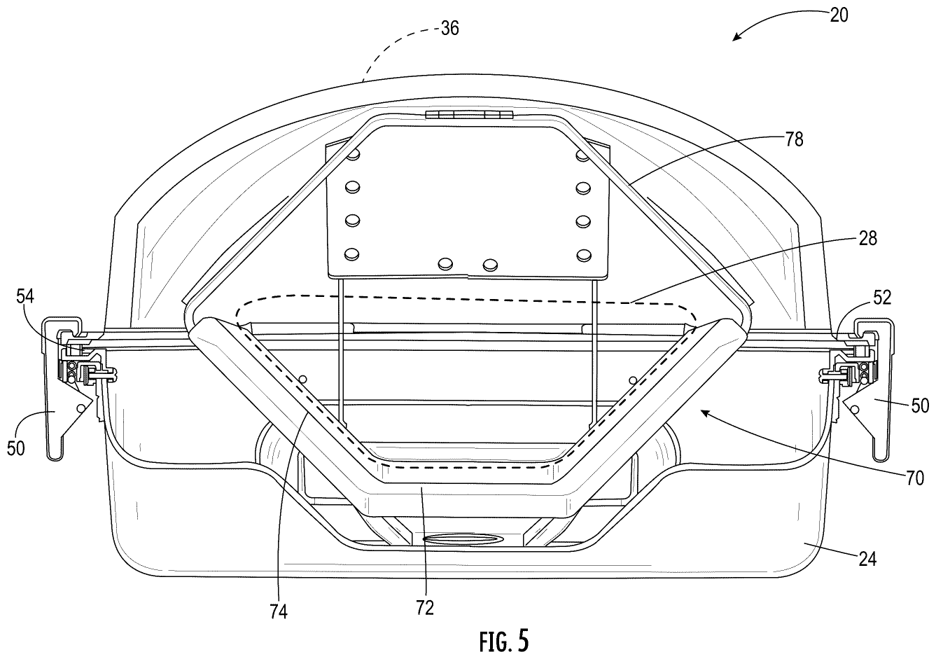

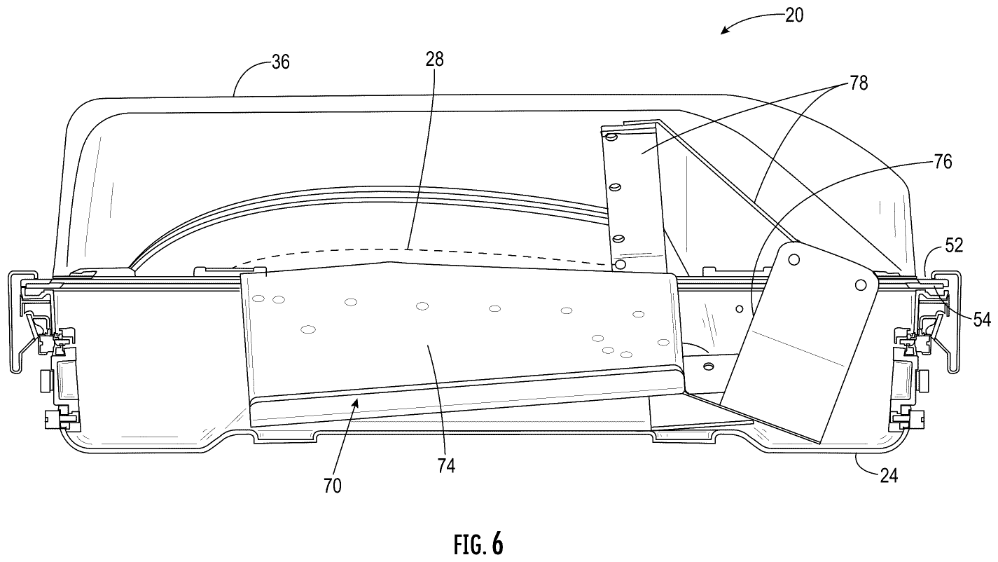

Referring now to FIGS. 1-6, an abdominal surgical simulation model is illustrated generally at 20 and includes a bottom tray 24 and animal tissue 28, such as harvested animal tissue or synthetic tissue, carried within the bottom tray as shown in FIGS. 4-6 where the animal tissue is shown schematically by the dashed line. A convex support layer 32 covers the bottom tray 24 and a compliant layer 36 is carried by the convex support layer (FIG. 1) to simulate abdominal skin in an insufflated state. The convex support layer 32 has at least one opening 38 therein to define an access port as shown in FIG. 1, where a portion of the compliant layer 36 is removed to show two openings within the convex support layer that define access ports. Two other openings 38 on the convex support layer 32 are shown by the dashed oval lines indicative of an opening under the compliant layer 36. Indicia 44 are positioned on the outer surface of the compliant layer 36 and aligned with the openings 38 to represent the location of the openings since the openings are hidden under the compliant layer. In this example, the indicia 44 are X's printed on the compliant layer 36 at a location corresponding to the center of the opening 38. The indicia 44 indicate to a surgeon-in-training the locations of any openings 38 and permit the surgeon to move the surgical tool to the location on the compliant layer 36 where the surgical tool can be inserted through the opening and reach the animal tissue 28.

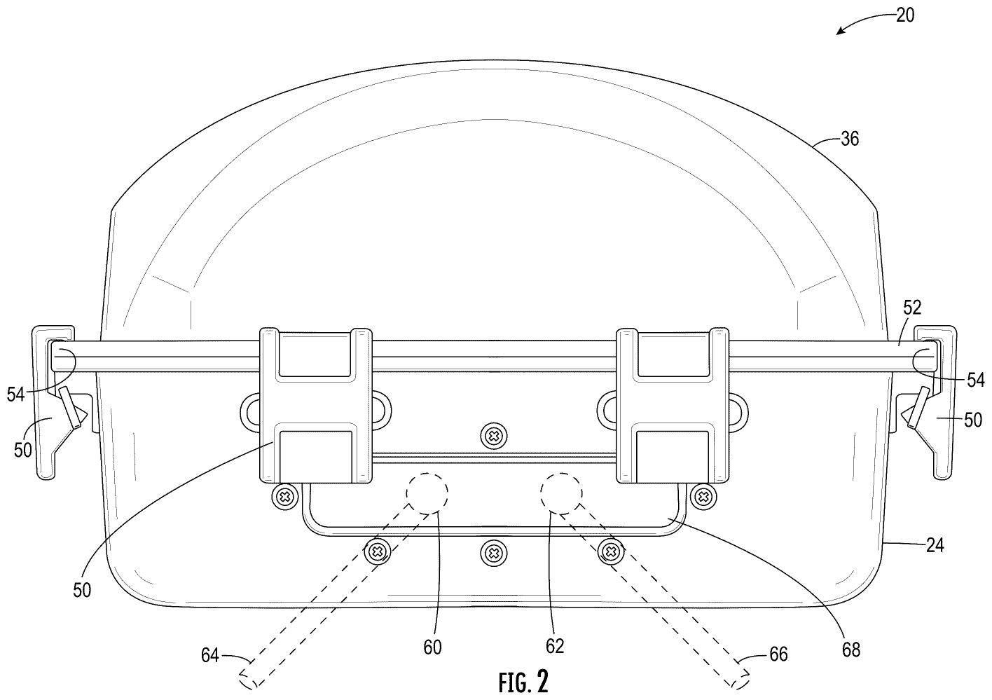

A coupling arrangement 50 removably secures the compliant layer 36 to the bottom tray 24, and in this example, defines a gas tight seal for insufflation so that CO₂ gas or other gas used for insufflation does not leak past the gas tight seal, but remains in the interior of the bottom tray and under the compliant layer for surgical training. The bottom tray 24 may be formed as illustrated in a substantially rectangular configuration from a plastic or metallic material. The coupling arrangement 50 may be formed as clamps or latches, such as injection molded components that are attached to the bottom tray 24 and clip or latch onto an outer rim 52 of the compliant layer 36. The clamps or latches as the coupling arrangement 50 press down against the outer rim 52 and secure the compliant layer 36 onto an outer flange 54 defining the upper edge of the bottom tray 24 (FIG. 2).

The outer flange 54 may be formed as a metal or polymer flange in an example. The gas tight seal may be formed from a rubber seal 58 positioned along the upper surface of the outer flange 54, or made from another sealing mechanism to form a gas tight seal for insufflation so that carbon dioxide gas or other gas used for insufflation will not leak out of the internal area defined by the bottom tray 24 and the compliant layer 36. In this example, the rubber seal 58 is shown by the dashed line along a portion of the upper surface of the outer flange 54 in FIGS. 1 and 4.

As best shown in the end view of FIG. 2, the bottom tray 24 has at least one line opening, and in this example, two line openings 60, 62 to allow a fluid line 64 and an electrical line 66 (all shown by dashed line configuration) to extend therethrough into the bottom tray 24 for passing fluid, such as fake blood, into the animal tissue 28, such as harvested animal tissue or synthetic tissue, and provide electrical current for electrocautery on the animal tissue via the electrical line. In an example shown in FIG. 2, an end panel 68 is retained over the end of the bottom tray 24 to cover the line openings 60, 62. The end panel 68 may be removed so that fluid or electrical fittings may be attached to the line openings 60, 62 and configured to receive the fluid line 64 and electrical line 66 respectively.

Referring to FIGS. 4-6, the convex support layer 32 and compliant layer 36 are shown in outline and a portion of the bottom tray 24 broken away in order to show a tissue cassette 70 carrying the animal tissue 28, such as harvested animal tissue or synthetic tissue. The tissue cassette 70 is removably positioned within the bottom tray 24. The animal tissue 28, in this example, may be harvested porcine tissue and shown by the dashed outline in each of FIGS. 4, 5 and 6. As noted above, the animal tissue 28 may be synthetic tissue, such as synthetic surgical tissues as materials that mimic the functions of natural tissues. These synthetic tissues may be organized in a 3D pattern and be 3D printed or molded. Examples may also include modified surgical mesh or hybrid tissues.

The tissue cassette 70 may be formed from a metallic material or other sheet metal material that is configured to hold the animal tissue 28, such as harvested animal tissue or synthetic tissue, and form an electrically conductive base for electrocautery. In this example, the tissue cassette 70 includes a planar bottom surface 72 and inclined sides 74 that retain the animal tissue 28 thereon. One end of the tissue cassette 70 may include a downward inclined, U-shaped section 76 that permits fluid from the animal tissue to flow down into the bottom tray 24.

A top bracket 78 having an upward inclined rear connects the inclined sides 74 and U-shaped section 76 of the tissue cassette 70 to help retain the animal tissue 28 onto the tissue cassette. Openings may be formed within the tissue cassette 70 to retain screws or other fasteners, such as wire, to help retain the animal tissue 28 onto the tissue cassette. An example tissue cassette 70 is disclosed in U.S. Patent Publication No. 2023/0290280, published on Sep. 14, 2023. In an example shown in FIGS. 4-6, the tissue cassette 70 is configured as a hernia plate, but may also be configured as a pelvic or colorectal or other support for animal tissue 28, such as harvested animal tissue or synthetic tissue, that simulates pelvic, colorectal, hernia or other abdominal surgery.

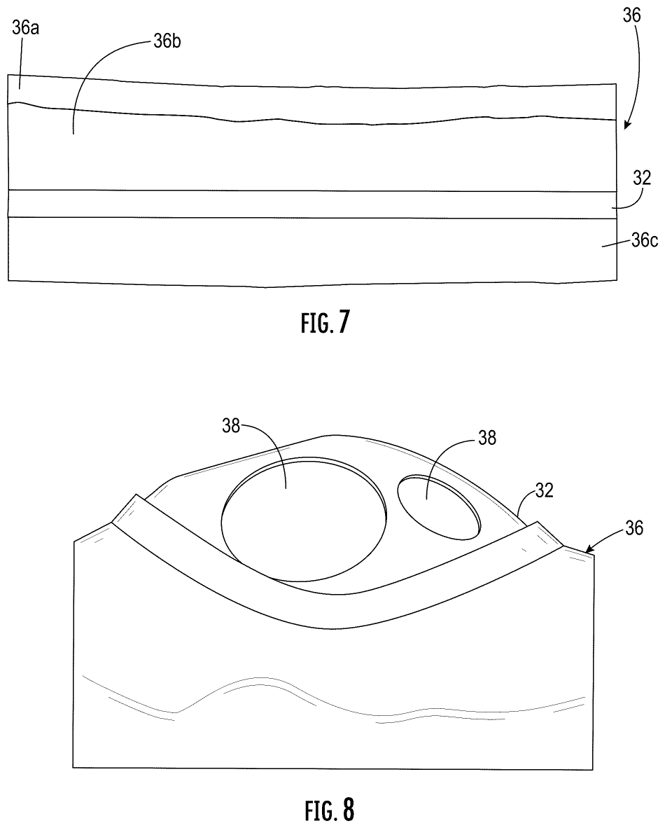

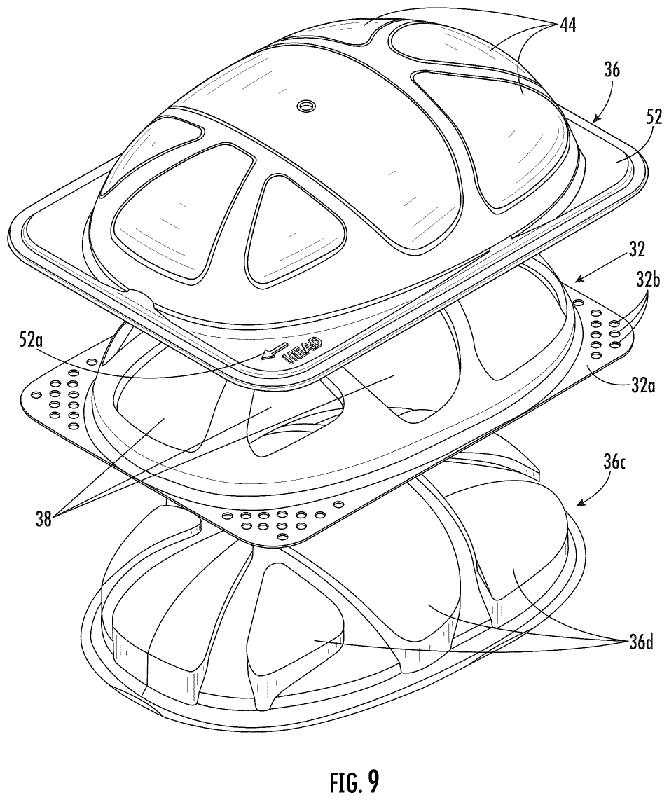

Referring now to FIGS. 7 and 8, the convex support layer 32 with two openings 38 is shown with a portion of the compliant layer 36 removed (FIG. 8), and a sectional view of the compliant layer shown in FIG. 7. The compliant layer 36 is carried by the convex support layer 32 and formed from a multilayer material, such as silicone, and in this example, positioned on both sides of the convex support layer. The compliant layer 36 may be formed from different layers of silicone, each layer being a different thickness, and in some examples, having different densities, and in the example of FIG. 7, the compliant layer 36 has a top 3 millimeter skin layer 36a attached to a 10 millimeter flat layer 36b positioned directly on the convex support layer 32, which may be formed from a flexible plastic or similar polymer material and be about 3 to 5 millimeters thick. The convex support layer 32 may be secured onto a lower side of the compliant layer 36 as another silicone layer, forming an inner layer 36c as a muscle layer in this example and may be about 5 millimeters thick. These dimensions for the different layers (36a, 36b, and 36c) may vary depending on design considerations and the type of abdominal surgical simulation required. Other materials besides silicone may be used to represent artificial skin.

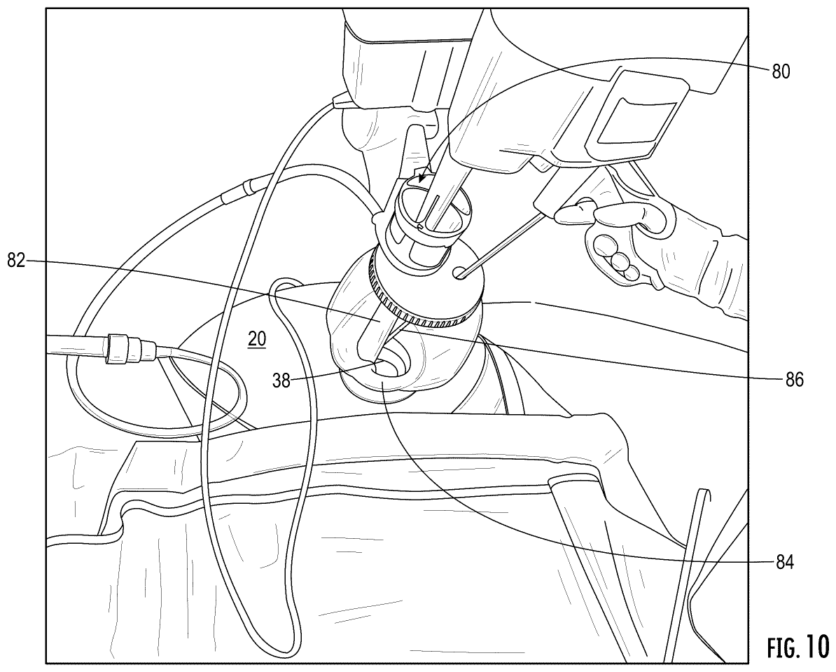

Referring now to FIG. 9, an exploded isometric view of another example of the compliant layer 36 as a skin layer and convex support layer 32 includes its inner layer 36c carried within the convex support layer. The convex support layer 32 may correspond to the convex support layer shown in FIGS. 7 and 8, but the example in FIG. 9 includes a side support outer rim 32a that is received under the outer rim 52 of the compliant layer 36. The convex support layer 32 in this example includes larger formed openings 38, including a central opening that extends along a substantial top segment of the upper convex portion of the convex support layer. The inner layer 36c may be carried within the convex support layer 32 and include molded sections 36d as protrusions, for example, that are configured to pass through the openings 38 in the convex support layer. This inner layer 36c may correspond to the inner layer 36c in FIG. 7.

The compliant layer 36 includes indicia 44 that correspond to the shapes of the openings 38 in the convex support layer 32 and the molded sections 36d in the inner layer 36c so that a surgical trainee training with the abdominal surgical simulation model 20 knows the configuration and where the openings are located. The indicia 44 could be printed or formed into the compliant layer 36 or other techniques used to form the indicia.

The compliant layer's outer rim 52 may include an arrow 52a with the word “HEAD” imprinted thereon in order to signify the direction that the convex support layer 32, inner layer 36c, and compliant layer 52 are positioned in the abdominal surgical simulation model 20. The corners of the side support outer rim 32a may include small openings 32b that help reduce weight without excessive weakening of the convex support layer 32.

In an example, the convex support layer 32, inner layer 36c, and compliant layer 36 as the skin layer may be formed from silicone and bonded or compression molded together so the inner layer, convex support layer, and compliant layer as the skin layer do not delaminate when they are stored in an unsupported position. As a non-limiting example, the inner layer 36c may be formed from a Shore A20 hardness silicone material corresponding to a hardness similar to a rubber band. In other examples, the inner layer 36c may range from Shore 002 to Shore 20 so that the material used for the inner layer may be extra soft and correspond to a hardness similar to a “gummi” jelly candy or soft gel shoe insole and extend up to a hardness similar to a rubber band at about Shore 20.

The convex support layer 32 may be formed from a Shore 85 hardness silicone material corresponding to harder silicon material than the inner layer 36c, for example, the hardness of a shoe heel. The compliant layer 36 as the skin layer may be formed from a Shore 20 hardness silicone material similar in hardness to a rubber band. The thickness of the convex support layer 32, inner layer 36c, and compliant layer 36 may vary. The molded protrusions 36d at the inner layer 36c may be about 0.6 to about 1.0 inches in thickness, and the compliant layer 36 as the skin layer may be about 0.125 inches thick and range about +/−0.025 inches from that average dimension. These dimensions are general ranges and can vary depending on application and design requirements. The convex support layer 32 in this example forms a frame that keeps the structure, i.e., compliant layer 36, convex support layer 32, and inner layer 36c, from collapsing under external pressure.

Referring now to FIG. 10, an environmental view of the abdominal surgical simulation model 20 is shown with a robotic surgery system having a robotic surgical arm 80 and surgical tools 82 inserted through an opening 38 as a single port access of the abdominal surgical simulation model. A floating dock 84 system is used with the single port surgery as shown. In this example, the robotic surgery arm 80 carries different surgical tools, including an optical endoscope that accesses the single port access opening 38. The robotic surgery arm 80 may also carry a manually held laparoscopic tool 86 that passes through the single port access opening 38.

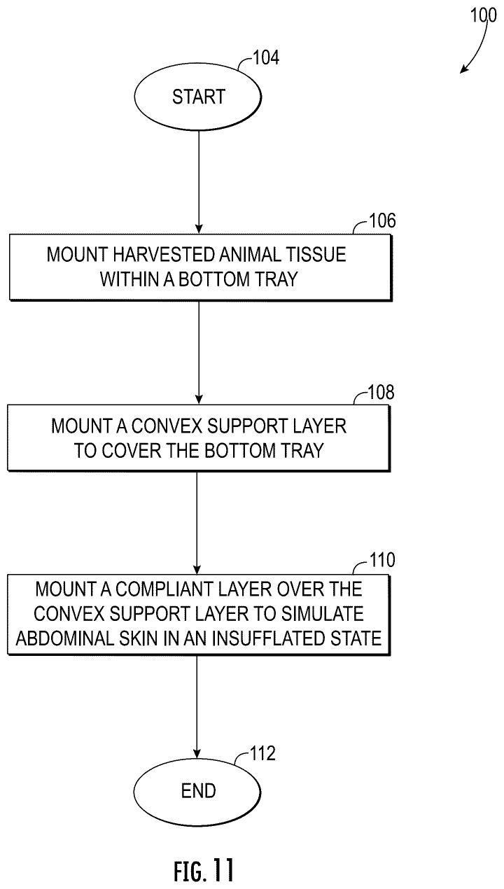

Referring now to FIG. 11, a high-level flowchart of a method of making the abdominal surgical simulation model 20 is illustrated generally at 100. The method starts (Block 104) and animal tissue 28, such as harvested animal tissue or synthetic tissue, is mounted within the bottom tray 24 such as contained in the tissue cassette 70 (Block 106). A convex support layer 32 is mounted to cover the bottom tray 24 (Block 108). A compliant layer 36 is mounted over the convex support layer 32 to simulate abdominal skin in an insufflated state (Block 110). The process ends (Block 112).

The real-tissue surgical training model 100 may be used, for example, with remotely operated, computer-assisted or teleoperated surgical systems, such as those described in, for example, U.S. Pat. No. 9,358,074 (filed May 31, 2013) to Schena et al., entitled “Multi-Port Surgical Robotic System Architecture,” U.S. Pat. No. 9,295,524 (filed May 31, 2013) to Schena et al., entitled “Redundant Axis and Degree of Freedom for Hardware-Constrained Remote Center Robotic Manipulator,” and U.S. Pat. No. 8,852,208 (filed Aug. 12, 2010) to Gomez et al., entitled “Surgical System Instrument Mounting,” each of which is hereby incorporated by reference in its entirety. Further, the real-tissue surgical training model 100 described herein may be used, for example, with a da Vinci® Surgical System, such as the da Vinci X® Surgical System or the da Vinci Xi® Surgical System, both with or without Single-Site® single orifice surgery technology, all commercialized by Intuitive Surgical, Inc., of Sunnyvale, California. Although various embodiments described herein are discussed in connection with a manipulating system of a teleoperated surgical system, the present disclosure is not limited to use with a teleoperated surgical system. Various embodiments described herein can optionally be used in conjunction with handheld instruments, such as laparoscopic tools for real-time surgical training with a harvested porcine tissue cassette.

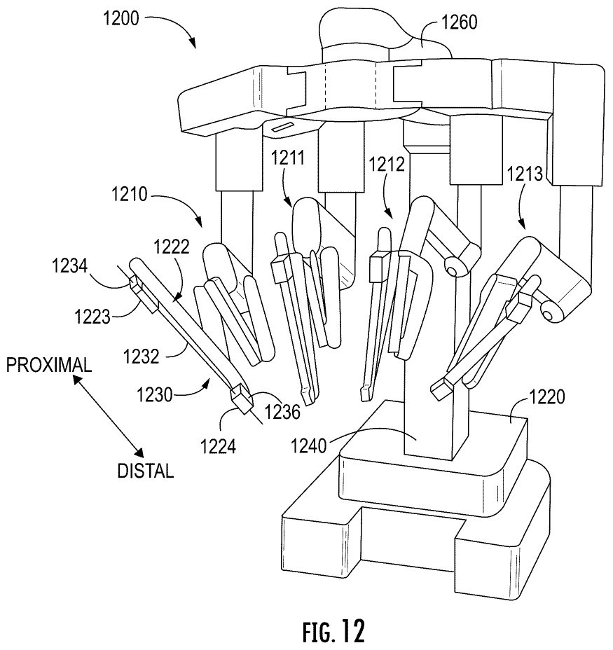

As discussed above, in accordance with various embodiments, surgical tools or instruments of the present disclosure are configured for use in teleoperated, computer-assisted surgical systems employing robotic technology (sometimes referred to as robotic surgical systems). Referring now to FIG. 12, an embodiment of a manipulator system 1200 of a computer-assisted surgical system, to which surgical instruments are configured to be mounted for use, is shown. Such a surgical system may further include a user control system, such as a surgeon console (not shown) for receiving input from a user to control instruments coupled to the manipulator system 1200, as well as an auxiliary system, such as auxiliary systems associated with the DA VINCI X® and DA VINCI XI®, Da Vinci SP.

As shown in the embodiment of FIG. 12, a manipulator system 1200 includes a base 1220, a main column 1240, and a main boom 1260 connected to main column 1240. Manipulator system 1200 also includes a plurality of manipulator arms 1210, 1211, 1212, 1213, which are each connected to main boom 1260. Manipulator arms 1210, 1211, 1212, 1213 each include an instrument mount portion 1222 to which an instrument 1230 may be mounted, which is illustrated as being attached to manipulator arm 1210.

Instrument mount portion 1222 may include a drive assembly 1223 and a cannula mount 1224, with a transmission mechanism 1234 of the instrument 1230 connecting with the drive assembly 1223, according to an embodiment. Cannula mount 1224 is configured to hold a cannula 1236 through which a shaft 1232 of instrument 1230 may extend to a surgery site during a surgical procedure. Drive assembly 1223 contains a variety of drive and other mechanisms that are controlled to respond to input commands at the surgeon console and transmit forces to the transmission mechanism 1234 to actuate the instrument 1230. Although the embodiment of FIG. 12 shows an instrument 1230 attached to only manipulator arm 1210 for ease of viewing, an instrument may be attached to any and each of manipulator arms 1210, 1211, 1212, 1213.

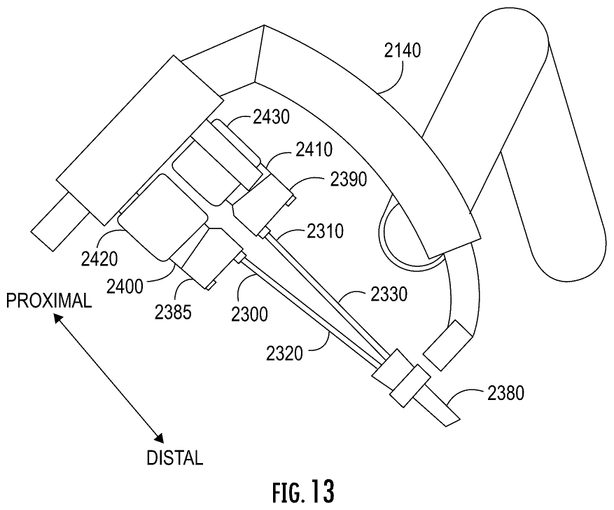

Other configurations of surgical systems, such as surgical systems configured for single-port surgery, are also contemplated. For example, with reference now to FIG. 12, a portion of an embodiment of a manipulator arm 2140 of a manipulator system with two surgical instruments 2300, 2310 in an installed position is shown. The surgical instruments 2300, 2310 can generally correspond to different instruments used for real-time tissue training using the harvested porcine tissue cassette. For example, the embodiments described herein may be used with a DA VINCI SP® Surgical System, commercialized by Intuitive Surgical, Inc. of Sunnyvale, California. The schematic illustration of FIG. 13 depicts only two surgical instruments for simplicity, but more than two surgical instruments may be mounted in an installed position at a manipulator system as those having ordinary skill in the art are familiar. Each surgical instrument 2300, 2310 includes a shaft 2320, 2330 having at a distal end a moveable end effector or an endoscope, camera, or other sensing device, and may or may not include a wrist mechanism (not shown) to control the movement of the distal end.

In the embodiment of FIG. 13, the distal end portions of the surgical instruments 2300, 2310 are received through a single port structure 2380 to be introduced into the harvested porcine tissue through the opening of the mouth and associated upper and lower jaws and into communication with the oropharynx region. As shown, the port structure includes a cannula and an instrument entry guide inserted into the cannula. Individual instruments are inserted into the entry guide to reach a surgical site corresponding to the oropharynx region of the porcine tissue that simulates the oropharynx region of the human body.

Other configurations of manipulator systems that can be used in conjunction with the present disclosure can use several individual manipulator arms. In addition, individual manipulator arms may include a single instrument or a plurality of instruments. Further, as discussed above, an instrument may be a surgical instrument with an end effector or may be a camera instrument or other sensing instrument utilized during a surgical procedure to provide information, (e.g., visualization, electrophysiological activity, pressure, fluid flow, and/or other sensed data) of a remote surgical site.

Transmission mechanisms 2385, 2390 are disposed at a proximal end of each shaft 2320, 2330 and connect through a sterile adaptor 2400, 2410 with drive assemblies 2420, 2430, which contain a variety of internal mechanisms (not shown) that are controlled by a controller (e.g., at a control cart of a surgical system) to respond to input commands at a surgeon side console of a surgical system to transmit forces to the force transmission mechanisms 2385, 2390 to actuate surgical instruments 2300, 2310.

The embodiments described herein are not limited to the embodiments of FIGS. 12 and 13, and various other teleoperated, computer-assisted surgical system configurations may be used with the embodiments described herein. The diameter or diameters of an instrument shaft and end effector are generally selected according to the size of the cannula with which the instrument will be used and depending on the surgical procedures being performed.

This description and the accompanying drawings that illustrate various embodiments should not be taken as limiting. Various mechanical, compositional, structural, electrical, and operational changes may be made without departing from the scope of this description and the invention as claimed, including equivalents. In some instances, well-known structures and techniques have not been shown or described in detail so as not to obscure the disclosure. Like numbers in two or more figures represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to another embodiment, the element may nevertheless be claimed as included in the other embodiment.

For the purposes of this specification and appended claims, unless otherwise indicated, all numbers expressing quantities, percentages, or proportions, and other numerical values used in the specification and claims, are to be understood as being modified in all instances by the term “about,” to the extent they are not already so modified. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the invention. For example, spatially relative terms-such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions (i.e., locations) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the example term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various embodiments shown and described herein are to be taken as examples. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

It is to be understood that the particular examples and embodiments set forth herein are non-limiting, and modifications to structure, dimensions, materials, and methodologies may be made without departing from the scope of the present teachings.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An abdominal surgical simulation model comprising:
a bottom tray;
animal tissue carried within the bottom tray;
a convex support layer covering the bottom tray; and
a compliant layer carried by the convex support layer to simulate abdominal skin in an insufflated state.

2. The abdominal surgical simulation model of claim 1 wherein the convex support layer has at least one opening therein to define an access port.

3. The abdominal surgical simulation model of claim 2 further comprising indicia on an outer surface of the compliant layer aligned with the at least one opening.

4. The abdominal surgical simulation model of claim 1 comprising a coupling arrangement to removably secure the compliant layer to the bottom tray.

5. The abdominal surgical simulation model of claim 4 wherein the coupling arrangement defines a gas tight seal for insufflation.

6. The abdominal surgical simulation model of claim 1 wherein the bottom tray has at least one opening therethrough; and comprising at least one of a fluid line and electrical line extending therethrough.

7. The abdominal surgical simulation model of claim 1 wherein the animal tissue comprises harvested animal tissue.

8. The abdominal surgical simulation model of claim 7 wherein the harvested animal tissue comprises harvested porcine tissue.

9. The abdominal surgical simulation model of claim 1 wherein the animal tissue comprises synthetic tissue.

10. The abdominal surgical simulation model of claim 1 comprising a base coupled to the animal tissue defining a tissue cassette; and wherein the tissue cassette is removably positioned within the bottom tray.

11. The abdominal surgical simulation model of claim 1 comprising an inner layer carried within the convex support layer.

12. An abdominal surgical simulation model comprising:
a bottom tray;
an electrically conductive base;
harvested porcine tissue carried by the electrically conductive base and within the bottom tray;
a convex support layer covering the bottom tray; and
a compliant layer carried by the convex support layer to simulate abdominal skin in an insufflated state.

13. The abdominal surgical simulation model of claim 12 wherein the convex support layer has at least one opening therein to define an access port.

14. The abdominal surgical simulation model of claim 13 further comprising indicia on an outer surface of the compliant layer aligned with the at least one opening.

15. The abdominal surgical simulation model of claim 12 comprising a coupling arrangement to removably secure the compliant layer to the bottom tray.

16. The abdominal surgical simulation model of claim 15 wherein the coupling arrangement defines a gas tight seal for insufflation.

17. The abdominal surgical simulation model of claim 12 wherein the bottom tray has at least one opening therethrough; and comprising at least one of a fluid line and electrical line extending therethrough.

18. A method for making an abdominal surgical simulation model comprising:
mounting animal tissue within a bottom tray;
mounting a convex support layer to cover the bottom tray; and
mounting a compliant layer over the convex support layer to simulate abdominal skin in an insufflated state.

19. The method of claim 18 wherein the convex support layer has at least one opening therein to define an access port.

20. The method of claim 19 further comprising forming indicia on an outer surface of the compliant layer aligned with the at least one opening.

21. The method of claim 18 comprising removably securing the compliant layer to the bottom tray with a coupling arrangement.

22. The method of claim 21 wherein the coupling arrangement defines a gas tight seal for insufflation.

23. The method of claim 18 wherein the bottom tray has at least one opening therethrough; and comprising at least one of a fluid line and electrical line extending therethrough.

24. The method of claim 18 wherein the animal tissue comprises harvested animal tissue.

25. The method of claim 24 wherein the harvested animal tissue comprises harvested porcine tissue.

26. The method of claim 18 wherein the animal tissue comprises synthetic tissue.

27. The method of claim 18 comprising mounting a base to the animal tissue defining a tissue cassette; and wherein the tissue cassette is removably positioned within the bottom tray.
